(19) United States
(12) Patent Application Publication
(10) Pub. No.: US 2007/0174330 A1
(43) Pub. Date: Jul. 26, 2007

(54) Mobile report generation for multiple device platforms

(75) Inventors: David Fox, San Francisco, CA (US); Kelli Fox, San Francisco, CA (US)

Correspondence Address: PERKINS COIE LLP, P.O. BOX 2168, MENLO PARK, CA, 94026, US

(73) Assignee: ZDK Interactive Inc., San Francisco, CA (US)

(21) Appl. No.: 11/487,171

(22) Filed: Jul. 13, 2006

Related U.S. Application Data
(63) Continuation-in-part of application No. 11/282,263, filed on Nov. 18, 2005.
Application No. 11/282,263 is a division of application No. 10/644,947, filed on Aug. 19, 2003.
(60) Provisional application No. 60/702,020, filed on Jul. 22, 2005.

(30) Foreign Application Priority Data
Nov. 25, 2002 (CN) PCT/CN02/00843

(51) Int. Cl. G06F 7/00

(52) U.S. Cl. 707/102

(57) ABSTRACT

A system and method of generating reports is disclosed. In one embodiment, a user requests a report using a GUI on a device and the request is sent to a report generation server. The report generation server generates the report and sends the report to the requesting device. In another embodiment, a user request a report be generated and sent to another device. The report generation server generates the report according to a format and platform of the intended recipient device and delivers the report.

### PRIORITY CLAIM TO RELATED APPLICATION

The present application claims priority to Fox et al.'s Provisional Patent Application No. 60/702,020 for Computer Implemented Character Creation For An Interactive User Experience, filed on Jul. 22, 2005 and Fox et al.'s Utility patent application Ser. No. 11/281,263 for Computer Implemented Character Creation For An Interactive User Experience, filed on Nov. 15, 2005, both of which are incorporated herein by reference.

### BACKGROUND OF THE INVENTION

1. Field of Technology

The present invention relates to a method and system for generating reports. Several embodiments teach a report generating system implemented across one or more device platforms, capable of generating reports for multiple applications, across various multimedia, for all conceivable sorts of content. The present invention also teaches a system and a method that enable personally tailored reports to be generated on multiple device platforms based on user supplied data.

2. Description of Related Art

FIG. 1 illustrates a prior art method 10 for generating and delivering content to a user. As shown, in a step 12 a desktop application is provided to a user. The desktop application enables the user to generate reports on a desktop computer. Typically, the desktop application is supplied by an Internet report provider. In response to the desktop application, the user submits information which is stored in a database. A step 114 generates a requested report in a suitable format according to the prior art. Commonly, the generation is done by one or more processors. Once generated, the report is delivered via the Internet to the user's desktop.

FIG. 2 illustrates a prior art method 20 for generating and delivering an astrological report to a user. As shown, in a step 12 a desktop astrology application is provided to a user. The desktop application enables the user to generate reports on a desktop computer. Typically, the desktop astrology application is supplied by an Internet astrology report provider. In response to the desktop astrology application, the user submits information which is stored in a database. A step 114 generates a requested astrology report in a suitable format according to the prior art. Commonly, the generation is done by one or more processors. Once generated, the astrology report is delivered via the Internet to the user's desktop.

As shown above, the user is restricted to a computer to receive generated reports. Further, as illustrated above, the user is restricted to where a computer can access the Internet to receive a generated report.

What is needed is a system and method that allows a user to obtain specified content on a mobile platform. Further, what is needed is a report generating interface that can be implemented across a variety of platforms.

### SUMMARY OF THE INVENTION

The present invention provides methods and systems that allows a user to obtain reports on a mobile platform. In one embodiment, a computer implemented method for generating reports comprises initiating a report generating system. After the initiation, instructions are executed that are associated with the report generating system. The instructions include providing a first GUI for a user to access the reporting generating system. The first GUI is suitable for a first device platform. The instructions also include obtaining at least some data required to generate a first report where the first report is suitable for one of a plurality of device platforms. A suitable and well defined action is determined based at least in part on the initiation and the executed instructions. A suitable and well-defined action is then initiated and if possible, attended to.

In further embodiments, the act of initiating the report generating system includes a plurality of housekeeping functions. The housekeeping functions can include establishing communications among devices and processes and allocating memory and other resources. In other embodiments, the generated report is an astrological report.

In another embodiment, a computer implemented report generating system comprises a client computer system and a server computer system. The client computer system includes a display device and a GUI. The GUI can be suitable for user interaction and operable to request a report. The server computer system includes a server process operable to respond to a request to generate a report. The server computer system generates and provides the report to the client computer system in response to user interaction with the GUI. In additional embodiments, the report generated can be an astrological report.

In further embodiments, the client computer system can additionally include a local server process and a proxy for remote server. The local sever process can receive data entered into the GUI and the proxy for remote server can transmit the data to the server computer system.

In other embodiments, the computer implemented report generating system can further comprise a second client computer system. The second client computer system can include a second display device. The server computer system can generate reports and provide the reports to the second client computer system. Moreover, in certain embodiments, the second client computer can further include a second GUI for the user to access the report generation system. Further, in another embodiment, the second client computer system can also include a second local server process and a second proxy for remote server. The second local server process can receive data entered into the second GUI and the second proxy for remote server can transmit the data to the sever computer system.

In additional embodiments, the report generating system can further comprise a first device. The first device can be configured to receive a generated report from the report generating sever and be capable of displaying the generated report. In another embodiment, the report generating system further comprises a second device. The second device can be configured to receive a generated report from the report generating server and be capable of displaying the generated report.

Another embodiment of the present invention is a method for generating a report. The method comprises providing a GUI to a user to access a report-generating application. After the GUI has been provided, a user request to generate a report is received from the GUI. Data required to generate the report is then obtained. The report is generated using the obtained data. After the report is generated, the report is provided to the user.

In alternate embodiments, providing a GUI can include certain steps. In one embodiment, a device platform is detected. Media and media players can also be detected, as well as required user-specific parameters. Once detection is complete, the initialization process for implementing the GUI is performed. The GUI is then implemented based on the results from the detection and certain fixed parameters.

In further embodiments, obtaining data required to generate the report can include certain steps. In one embodiment, locally available data and remotely available data is obtained. Obtaining data can also include interactively obtaining data from the user.

Generating the requested report can include additional steps in other embodiments. In a certain embodiment, a suitable format for the report is determined. Once determined, data for the report is compiled. The report is then created using the compiled data.

In another embodiment, a method for generating a report is disclosed. The method comprises requesting a report using a GUI on a mobile handheld device. Once the request is made, the request is sent to a report generation server. The report generation server generates the report according to the request. The generated report is then sent to the mobile handheld device. In a certain embodiment, the report is an astrological report.

In an additional embodiment, another method for generating a report is disclosed. The method comprises requesting a report using a GUI on a mobile handheld device. The request is sent to a report generation server. The report generation server generates a first report and a second report according to the request. The report generation server formats the first report according to the format and platform of the mobile handheld device. The report generation server formats the second report according to the format and platform of an intended recipient device. The report generation server then delivers the first report to the mobile handheld device and the second report to the intended recipient device. In another embodiment, the first and second reports are astrological reports.

Another embodiment of the present invention is a mobile handheld device. In one embodiment, the handheld device comprises a GUI, a local process server, and a proxy for remote server. The GUI is capable of requesting a report and delivering the request to the local process sever. The GUI is also capable of receiving the report from the local process server and displaying the report. The local process server is capable of receiving the request from the GUI and delivering the request to the proxy for remote server. The local process server is also capable of receiving the report from the proxy for remote server and delivering the report to the GUI. The proxy for remote server is capable of receiving the request from the local process server and transmitting the request to a report generation server. The proxy for remote server is also capable of receiving the report from the report generation server and delivering the report to the local process server.

In a further embodiment, a report generation system is disclosed. The report generation system comprises a report generation server and a first mobile handheld device. The report generation server is capable of receiving a device report request. The report generation server is also capable of generating a plurality of reports, in a plurality of formats, for a plurality of platforms. The reports can be transmitted by the report generation server according to the device report request. The first mobile handheld device is operably coupled to the report generations server. The first mobile handheld device is capable of receiving a human report request, converting the human report request into a device report request and transmitting the device report request to the report generation server. Further, the first mobile handheld device is capable of receiving and displaying a first generated report from the report generation server.

In alternate embodiments, the report generation system can comprise a second device. The second device can have a different platform than the first mobile handheld device. The second device can be capable of receiving and displaying a second generated report from the report generation server which is compatible with the platform of the second device. In certain embodiments, the second device can be capable of receiving and converting the human report request into a device report request. The second device can also be capable of transmitting the device report request to the report generation server. In other embodiments, the first generated report and the second generated report can be an astrological report. In an additional embodiment, the human report request can comprise a birthdate and an intended recipient device. Further, the human report request can be received by navigating through various menus and making various selection using a GUI.

As discussed above, various systems and methods for generating reports are disclosed. The systems and methods allow a report to be requested on a first device, generated by a report generation server, and displayed on the requesting device or a plurality of other devices. Further, the systems and methods allow the generated report to be received and displayed by devices with differing formats and platforms.

### BRIEF DESCRIPTION OF THE DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates a prior art method of generating and delivering content.

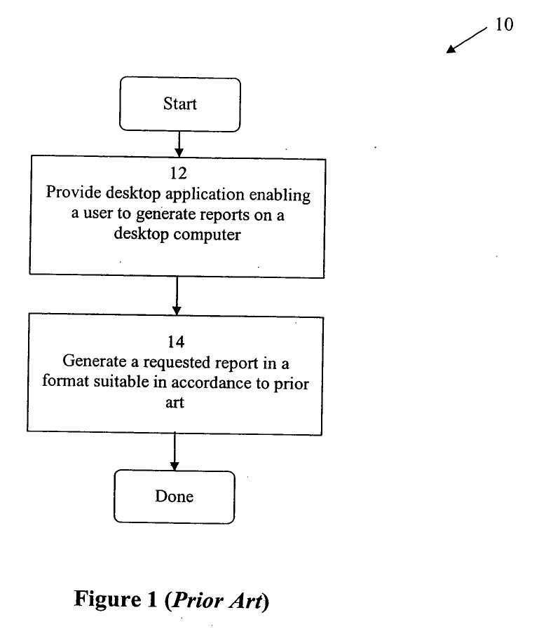

FIG. 2 illustrates a prior art method of generating and delivering an astrological report.

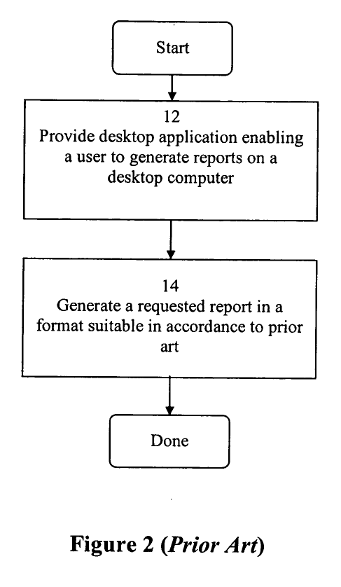

FIG. 3 illustrates a report generating system.

FIG. 4 illustrates a method of generating reports.

FIG. 5 illustrates a method of installing and using a GUI.

FIG. 6 illustrates another embodiment of a method of generating reports.

FIG. 7 illustrates a method of implementing a GUI.

FIG. 8 illustrates a method of obtaining data.

FIG. 9 illustrates another embodiment of a method of generating reports.

FIG. 10 illustrates a flow chart of report generating system.

### DETAILED DESCRIPTION OF DRAWINGS

The present invention teaches a variety of devices, methods, and other subject matter described herein or apparent to one skilled in the art in light of the present teaching. The present invention further teaches a variety of embodiments, aspects and the like, all distinctive in their own right. The person of skill in the art suitable for the present invention can have a background from computer science, computer engineering, electrical engineering, or the like.

As discussed above, a variety of systems and methods for generating reports is disclosed. The systems and methods allow a report to be requested on a first device, generated by a report generation server, and displayed on the requesting device or a plurality of other devices. Further, the systems and methods allow the generated report to be received and displayed by devices with differing formats and platforms.

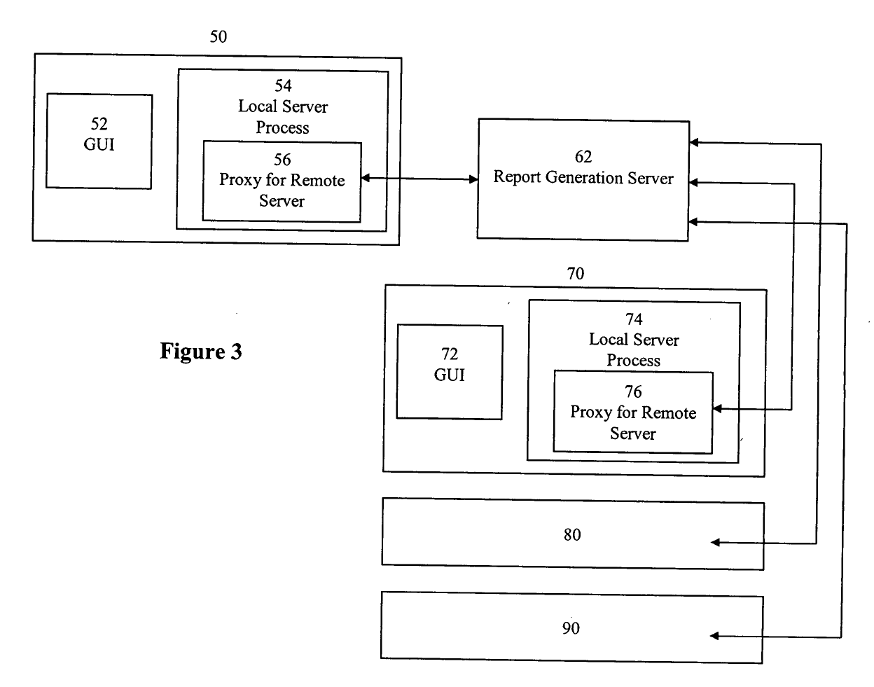

FIG. 3 illustrates a report generating system 40 according to one embodiment. The report generating system 40 includes a first device 50, a second device 70, a third device 80, a fourth device 90 and a report generation server 62. As illustrated, the first device includes a GUI 52, a local server process 54, and a proxy for remote server. The second device also includes a GUI 72, a local server process 74 and a proxy for remote server 76. The report generation server 62 can communicate with the four devices 50, 70, 80, and 90. In regard to the first device 50 and second device 70, the report generation server 62 communicates with the respective proxy for remote servers 56, 76. However, the proxy for remote server is optional as illustrated by the report generation server 62 communicating with the third device 80 and the fourth device 90.

In the embodiment illustrated, the first device 50 is a mobile telephone. As illustrated, a user can interact with the GUI 52 on the mobile telephone and request a report. In this embodiment, the report can be an astrological report. The request can be processed by the local server process 54 and sent to the report generation server 62 via the proxy for remote server 56. The report generation server 62 can then generate and deliver the astrological report to the mobile telephone 50.

In a further embodiment, the user can interact with the GUI 52 and request a report to be delivered to another device. The request can be sent to the report generation server 62 and the report generation server can format the report according to the platform of the intended recipient device(s). The report generation server 62 then transmits the report to one or more other devices 70, 80, 90 in the appropriate format and platform.

By way of a non-limiting example, the user can request on the mobile telephone 50 that a report be generated and sent to the second device 70, a personal computer. The report generation server 62 can then generate the report according to the format and platform of the personal computer 70 and send the report. The user can then access the report on the personal computer 70 by interacting with the GUI 72. In another example, the user can request a report be generated and sent to the third device 80, a mobile handheld device. The report generation server 62 can then generate the report according to the format and platform of the mobile handheld device 80 and send the report. The user can then access the report on the mobile handheld device 80.

In alternate embodiments, a variety of platforms can be supported. For example, the devices 50, 70, 80, 90 can be a mobile telephone, BlackBerry, Palm Pilot, laptop computer, tablet computer, terminal, mobile handheld computing device, or any other device capable of receiving a generated report. Additionally, in a certain embodiment, the one or more devices each have the same device platform. In another embodiment, the one or more devices can each have a distinct platform while in yet another embodiment, some of devices can have the same platform while the other device have distinct platforms.

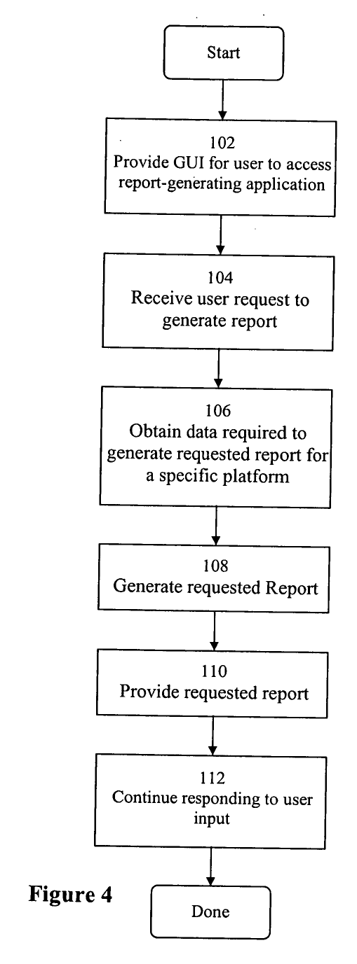

FIG. 4 illustrates a method 100 for generating reports. In a step 102, a user accesses a report generating application. In the embodiment illustrated, the user interacts with a GUI on a first device which can have a variety of platforms (as described above). The user interaction with the GUI yields a request for a report. The request is received in step 104 by the report generation server. In a step 106, the report generation server obtains data necessary to generate the request report. The data can include a specification for a preferred format and/or platform of the intended recipient device. A step 108 generates the requested report. In alternate embodiments the report generating application can generate a variety of reports. By way of a non-limiting example, the report generation application can generate financial, health, life, work, dating, love, advice, mood, predictive, relationship, friend, family, astrological and/or any other reports suitable for generation. The generated report is provided to the user in a step 110. A step 112 determines whether the user wants to generate another report and if so, the step 102 provides the user with access to the GUI.

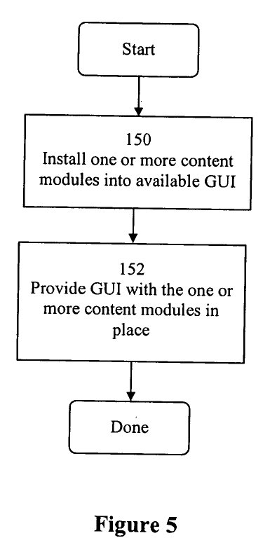

FIG. 5 illustrates a method 140 of installing and using a GUI in a report generating system. In the embodiment illustrated, a step 150 installs one or more content modules into an available GUI. The content modules can contain a variety of data which can provide options to generate a variety of reports. By way of a non-limiting example, the content module can contain content for generating financial, health, life, work, dating, love, advice, mood, predictive, relationship, friend, family, astrological and/or any other reports suitable for generation. Further, the content module can contain format and/or platform options for the requesting device and/or intended recipient device. A step 152 then provides the GUI with one or more of the content modules in place. The user can then interact with the GUI to generate a requested report.

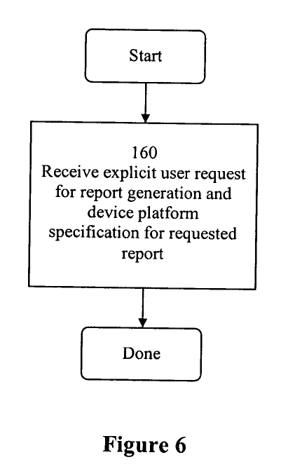

FIG. 6 illustrates a method 170 of generating a requested report. In the embodiment illustrated, a step 160 receives a request from a user to generate a report. The request can contain a variety of options selected by the user including, but not limited to, type of report, length of report, depth of report, subject(s) of report, status, delivery time, or any other options suitable for requesting a report. The step 160 also receives a specification for a format and/or platform of an intended recipient device. The step 160 can be performed by the report generation server which can deliver the report according to the request and specification provided by the user.

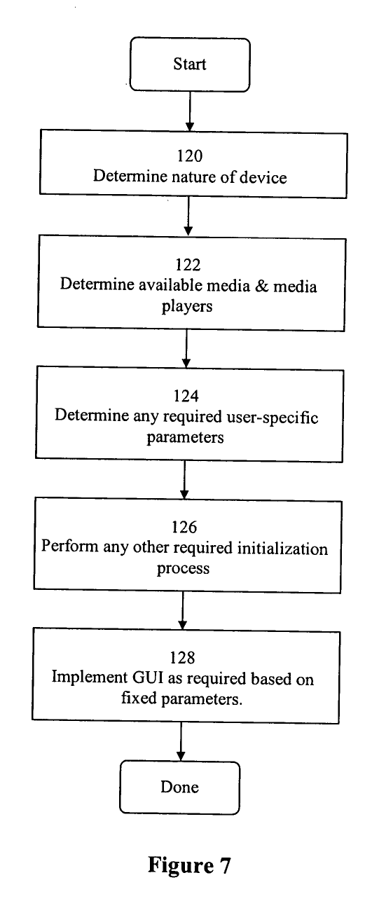

FIG. 7 illustrates a method 130 of implementing a GUI on a device. A step 120 initially determines the nature of the device. As discussed above, the device and platform can vary. Some examples include, but are not limited to, a mobile telephone, BlackBerry, Palm Pilot, laptop computer, tablet computer, terminal, mobile handheld computing device, or any other device capable of receiving a generated report. A step 122 determines the available media and media players. The detection method can be done in a variety of ways depending on the device and/or platform. A step 124 determines any required user-specific parameters. A user-specific parameter can include any option provided by the user, including options resulting from interaction with the GUI and/or a preset parameter by the sending device. A step 126 performs any other required initialization process necessary to implement a GUI. A step 128 implements the GUI based on the results of the previous steps and on any fixed parameters as determined by the hardware and/or software.

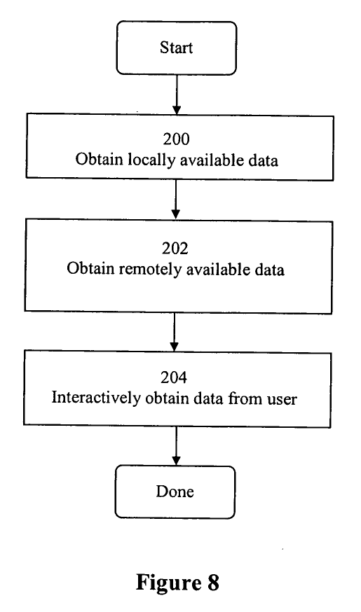

FIG. 8 illustrates a method 205 of obtaining data to generate a report. The method can be performed by a report generating server in response to a user's request for a report. A step 200 obtains locally available data. Locally available data can include any data that does not require a remote connection in order to access the data. Depending on configuration and convenience, locally available data can be data retrieved from an internal hard drive, external hard drive, CD-ROM, floppy disk, flash drive, local computer and/or can be data retrieved over a local area network from a local server. A step 202 obtains remotely available data. Remotely available data can include any data that does require a remote connection in order to access the data. Depending on configuration and convenience, remotely available data can include any data that can be retrieved over a network requiring a remote connection, including, but not limited to, data available over the Internet. A step 204 then interactively obtains data from a user. The data obtained from the user can include any data provided by the user, including data resulting from interaction with the GUI and/or any other data sent by the requesting device to facilitate the generation of a report. Once the local, remote and user data has been obtained, the report generation server can generate a report accordingly.

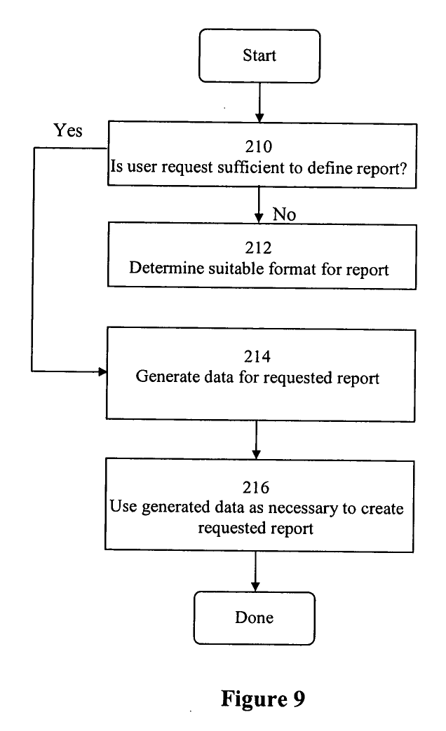

FIG. 9 illustrates a method for generating a report. In the embodiment illustrated, a step 210 determines whether a user request is sufficient to define a report. If not, a step 212 determines a suitable format for a report and the step 210 determines, once again, if the request is sufficient to define a report. Once the request is sufficient, a step 214 generates data for the requested report. The data can be generated as described in the embodiment shown in FIG. 8. A step 216 uses the generated data to create the requested report. The creation of the requested report can be facilitated in a variety of ways. For example, the requested report can be created using a preset and/or custom formula, template, format, configuration or system.

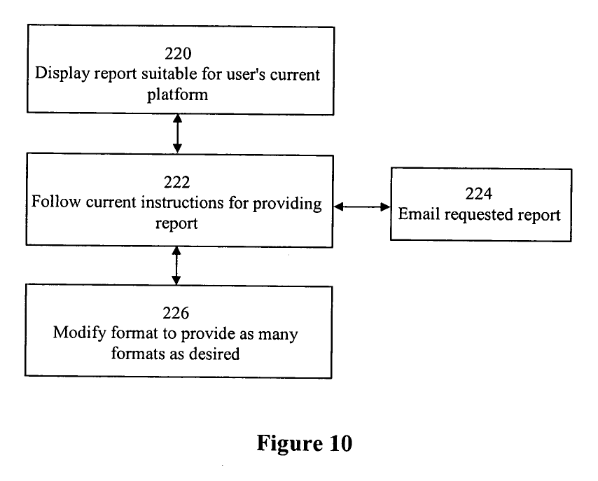

FIG. 10 illustrates a flow chart 230 of a system for generating and sending reports. In the embodiment illustrated, a step 220 displays a report suitable for a user's current platform. The device and platform can be, by way of example and not limitation, a mobile telephone, BlackBerry, Palm Pilot, laptop computer, tablet computer, terminal, mobile handheld computing device, or any other device capable of displaying a generated report. A step 222 follows current instructions for providing the report. A step 224 emails the requested report while a step 228 sends the report to a webpage. A step 226 modifies the format of the report to provide as many formats as desired.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

1. A computer implemented method for generating reports comprising:
a) initiate a report generating system;
b) execute instructions associated with said report generating system including:
i) provide a first GUI for a user to access said report generating system, said first GUI suitable for a first device platform, and
ii) obtain at least some data required to generate a first report, said first report suitable for a selected one of a plurality of device platforms;
c) determine a suitable and well defined action based at least in part on action a)-b); and
d) initiate and if possible attend to said suitable and well-defined action.

2. A computer implemented method as in claim 1, wherein the act of initiating said report generating system includes a plurality of housekeeping functions including:
establishing communications among devices and processes involved, and
allocating memory and other resources as necessary.

3. A computer implemented method as in claim 1, wherein said first report is an astrological report.

4. A computer implemented report generating system comprising:
a client computer system for a user, including:
a display device, and
a GUI suitable for user interaction and operable to request a report;
a server computer system including:
a server process operable to respond to a request to generate said report;
wherein said server computer system generates said report and provides said report to said client computer system in response to said request.

5. A computer implemented report generating system as recited in claim 4, wherein said report is an astrological report.

6. A computer implemented report generating system as recited in claim 4, wherein said client computer system further includes:
a local server process, and
a proxy for remote server;
wherein said local sever process receives data entered into said GUI and said proxy for remote server transmits said received data to said server computer system.

7. A computer implemented report generating system as recited in claim 4, further comprising:
a second client computer system including:
a second display device;
wherein said server computer system generates reports and provides said reports to said second client computer system.

8. A computer implemented report generating system as recited in claim 7, wherein said second client computer system further includes a second GUI suitable for user interaction and operable to request said report.

9. A computer implemented report generating system as recited in claim 8, wherein said second client computer system further includes:
a second local server process, and
a second proxy for remote server;
wherein said second local sever process receives data entered into said second GUI and said second proxy for remote server transmits said received data to said server computer system.

10. A computer implemented report generating system as recited in claim 4, further comprising:
a first device configured to receive said report from said server computer system, said first device capable of displaying said report.

11. A computer implemented report generating system as recited in claim 10, further comprising:
a second device configured to receive said report from said server computer system, said second device capable of displaying said report.

12. A method for generating a report comprising:
providing a GUI to a user to access a report-generating application;
receiving a user request to generate a report from said user via said GUI;
obtaining data required to generate said report;
generating said report using said obtained data; and
providing said report to said user.

13. A method for generating a report as recited in claim 12, wherein said providing step further comprises:
a. detecting a device platform;
b. detecting available media and media players;
c. detecting required user-specific parameters;
d. performing initialization process; and
e. implementing said GUI based on results of steps a-c and other fixed parameters.

14. A method for generating a report as recited in claim 12, wherein said obtaining step further comprises:
obtaining locally available data;
obtaining remotely available data; and
interactively obtaining data from said user.

15. A method for generating a report as recited in claim 12, wherein said generating step further comprises:
determining a suitable format for said report;
compiling data for said report; and
creating said report using compiled data.

16. A method for generating a report comprising:
sending a request for a report from a mobile handheld device to a report generation server;
generating said report according to said request; and
sending said report to said mobile handheld device.

17. A method for generating a report as recited in claim 16, wherein said report is an astrological report.

18. A method for generating a report comprising:
sending a request for a report from a mobile handheld device to a report generation server;
generating a first report and a second report according to said request;
formatting said first report according to a format and platform of said mobile handheld device;
formatting said second report according to a format and platform of another intended recipient device;
sending said first report to said mobile handheld device; and
sending said second report to said intended recipient device.

19. A method for generating a report as recited in claim 18, wherein said first report and said second report are astrological reports.

20. A mobile handheld device comprising:
a GUI,
a local process server, and
a proxy for remote server;
wherein said GUI is capable of requesting a report, delivering said request to said local process server, receiving said report from said local process server, and displaying said report,
wherein said local process server is capable of receiving said request from said GUI, delivering said request to said proxy for remote server, receiving said report from said proxy for remote server, and delivering said report to said GUI,
wherein said proxy for remote server is capable of receiving said request from said local process server, transmitting said request to a report generation server, receiving said report from said report generation server, and delivering said report to said local process server.

21. A report generation system comprising:
a report generation server capable of receiving a device report request, generating a plurality of reports in a plurality of formats for a plurality of platforms according to said device report request, and transmitting said plurality of generated reports according said device report request,
a first mobile handheld device operably coupled to said report generation server, said first mobile handheld device capable of receiving a human report request, converting said human report request into said device report request, and transmitting said device report request to said report generation server, said first mobile handheld device additionally capable of receiving a first generated report from said report generation server and displaying said first generated report.

22. A report generation system as recited in claim 21, further comprising,
a second device operably coupled to said report generation server, said second device having a different platform than said first mobile handheld device, said second device capable of receiving a second generated report from said report generation server and displaying said second generated report, said second generated report being compatible with said platform of said second device.

23. A report generation system as recited in claim 22, wherein said second device second device is capable of receiving said human report request, converting said human report request into said device report request, and transmitting said device report request to said report generation server.

24. A report generation system as recited in claim 23, wherein said first generated report and said second generated report is an astrological report.

25. A report generation system as recited in claim 21, wherein said human report request comprises:
at least one birthdate field, and
at least one intended recipient device field.

26. A report generation system as recited in claim 21, wherein said human report request is received by navigating thorough various menus and making various selections using a GUI.

27. A report generation system as recited in claim 22, wherein said second device is a mobile handheld device.

28. A report generation system as recited in claim 22, wherein said second device is a personal computer.
